(19) United States
(12) Patent Application Publication
(10) Pub. No.: US 2024/0166340 A1
(43) Pub. Date: May 23, 2024

(54) MAGNUS-EFFECT AIRCRAFT AND OPERATING METHOD THEREOF

(71) Applicant: AKTSIONERNOE OBSCHESTVO "ZENTORN", Moscow (RU)

(72) Inventors: Vladimir Alexandrovich VIYURKOV, Moscow (RU); Roman Dmitrievich LEBEDEV, Belgorod (RU)

(21) Appl. No.: 18/551,534

(22) PCT Filed: Aug. 18, 2022
(86) PCT No.: PCT/RU2022/050254

§ 371 Date: Sep. 20, 2023

(30) Foreign Application Priority Data
Aug. 25, 2021 (RU) 2021125150

(51) Int. Cl. B64C 23/08; B64C 21/06; B64U 30/30; B64U 10/20

(52) U.S. Cl. CPC B64C 23/08; B64C 21/06; B64U 30/30; B64U 10/20

(57) ABSTRACT

The invention relates to the field of aviation, in particular to the design of unmanned aerial vehicles for vertical take-off and landing. The apparatus is a polyhedral (for example, rectangular) body, with the cylinders 1 installed along its perimeter and capable of rotating. To supply air to the inside of the apparatus, the body has inlets 2 leading to the intake area and the gas supply area located within the body, where the centrifugal impellers 3 are installed at the top and at the bottom to create a forced flow of gas. At the outlet from the gas intake and supply area, as well as along the perimeter, there are flow channels located at the top and at the bottom, which have the form of cells 4 that extend into tunnel 5, which narrows at the outlet just before cylinder 1. The top and bottom flow channels are independent and not connected to each other. All rotating parts of the structure (impellers 3 and cylinders 1) are driven by engines 6 (electric engines, internal combustion engines (ICE)). There can be multiple impellers 3 on each side, at the top and at the bottom. The torque is compensated by the impellers 3 (those at the top compensate those at the bottom). The apparatus operates as follows: The gas enters into the body through the inlets 2. When the impellers 3 rotate, this causes the intake and supply of gas. The forced ram air created by the rotation of the centrifugal impellers 3 (shown with arrows on FIG. 2) passes through the cells 4 of the flow channel, which allows to split one continuous flow into several smaller ones and makes the air supply evenly distributed along the entire length of cylinders 1. After the cells, the flows pass through the tunnel 5 where they become narrower and get to the rotating cylinders 1. The narrowing of the gas flows increases their velocity, but reduces their impact on the cylinder area 1. The forced ram air that flows to the rotating cylinders 1 produces the Magnus effect on each cylinder 1. The torque of the upper impeller 3 is compensated by the torque of the lower impeller.

The invention relates to the field of aviation, in particular to the design of unmanned aerial vehicles for vertical take-off and landing.

A known unmanned aerial vehicle (quadcopter) is a radio-controlled aerial apparatus with four propellers that rotate diagonally in opposite directions, with one pair of propellers rotating clockwise and the other rotating counter-clockwise.

(https://quadrone.ru/blog/stati/kvadrakopter-chto-eto-takoe-i-kak-rabotaet)

The disadvantages of known analogs are small load capacity and the noise generated by the rotation of open propellers.

The task of the author was to create a low-noise unmanned aerial vehicle with a high load capacity for vertical take-off and landing.

This task was addressed by the essence of the claimed invention.

The essence of the invention is the ability to increase the load capacity of unmanned aerial vehicles and reduce noise during their operation by using the claimed apparatus with closed propellers (impellers) which, when rotated, create a forced flow of gas (air) directed to the rotating cylinders and, ultimately, produce Magnus effect.

The apparatus is a polyhedral (for example, rectangular) body, with the cylinders 1 installed along its perimeter and capable of rotating. To supply air to the inside of the apparatus, the body has inlets 2 leading to the intake area and the gas supply area located within the body, where the centrifugal impellers 3 are installed at the top and at the bottom to create a forced flow of gas. At the outlet from the gas intake and supply area, as well as along the perimeter, there are flow channels located at the top and at the bottom, which have the form of cells 4 that extend into tunnel 5, which narrows at the outlet just before cylinder 1. The top and bottom flow channels are independent and not connected to each other. All rotating parts of the structure (impellers 3 and cylinders 1) are driven by engines 6 (electric engines, internal combustion engines (ICE)). There can be multiple impellers 3 on each side, at the top and at the bottom. The torque is compensated by the impellers 3 (those at the top compensate those at the bottom).

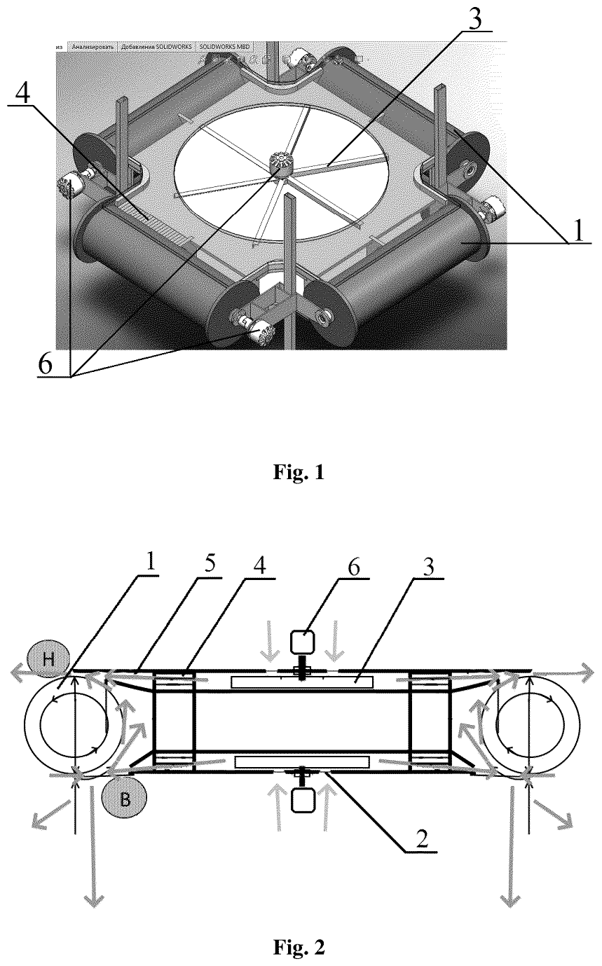

FIG. 1 shows an embodiment of the claimed apparatus with a rectangular body in an axonometric projection.

FIG. 2 shows the internal structure of the aerial vehicle with a rectangular body (side view) and the direction of forced flows (shown by arrows). The letters L and H designate the areas of low (L) and high (H) pressure, with the high-pressure area shifting to the left as the velocity of ram air increases.

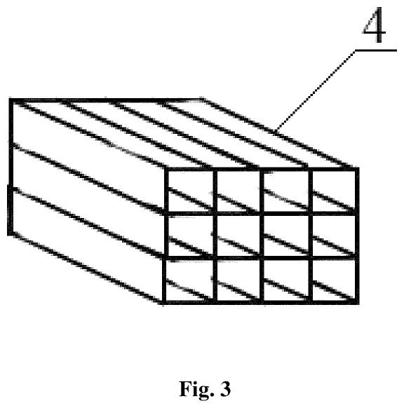

FIG. 3 shows an approximate view of cells.

### METHOD OF OPERATION OF THE APPARATUS

The gas enters into the body through the inlets 2. When the impellers 3 rotate, this causes the intake and supply of gas. The forced ram air created by the rotation of the centrifugal impellers 3 (shown with arrows on FIG. 2) passes through the cells 4 of the flow channel, which allows to split one continuous flow into several smaller ones and makes the air supply evenly distributed along the entire length of cylinders 1. After the cells, the flows pass through the tunnel 5 where they become narrower and get to the rotating cylinders 1. The narrowing of the gas flows increases their velocity, but reduces their impact on the cylinder area 1. The forced ram air that flows to the rotating cylinders 1 produces the Magnus effect on each cylinder 1. The torque of the upper impeller 3 is compensated by the torque of the lower impeller. The torque of each cylinder 1 is coordinated with the torque of all cylinders 1, thereby producing the Magnus effect in one direction. While differing on each cylinder 1 in terms of magnitude, the Magnus effect has the same direction, which allows to change the velocity and trajectory of the aerial vehicle.

FIG. 2 shows the distribution of flows at the top and at the bottom of cylinders and, with the design area reduced by half, the narrowing of gas flows increases the velocity of ram air.

ρ*(v+u)²/2+P2=ρ*(v−u)²/2+P1

ΔP=ρ*(v+u)²/2−ρ*(v−u)²/2

ΔP=ρ/2*((v²+2*v*u+u²)−(v²−2*v*u+u²))

ΔP=ρ/2*4*v*u

ΔP=ρ*2*v*u

F=ΔP*S/2

S=2*π*R*L

F=ΔP*2*π*R*L/2

F=ρ*2*v*u*2*π*R*L/2

F=ρ*v*u*2*π*R*L
Where:
ρ is the flow density;
v is the cylinder velocity;
u is the flow velocity;
P2 and P1 indicate static flow pressure at the top and at the bottom of the
cylinder;
ΔP is the pressure difference between the top and bottom of the cylinder;
S is the surface area of the cylinder;
F is the thrust produced by the Magnus effect;
R is the cylinder radius;
L is the cylinder length;

Since v=w*R, where w is the angular velocity of cylinder rotation, then

F=ρ*w*u*2*π*R²*L

Model Calculation (Example):
Diameter of each cylinder: 0.1 m;
Length of each cylinder: 0.5 m;
Rotation of cylinders: 6000 rpm;
Velocity of the ram air created by the impeller rotation: 17 m/sec;
The Magnus force will be equal to 431.8 N.

The invented apparatus can be controlled by positioning the cylinders and by changing the Magnus force on each cylinder. Also, if the torque is controlled at the intake and distribution of flows, this allows to ensure the rotation in additional (horizontal) plane.

The claimed invention can be used for reconnaissance, cargo delivery, transportation of people and machines (if the apparatus is made larger and more powerful), construction, meteorology, emergency medical aid, postal service, etc. Also, the claimed apparatus can operate by creating a forced flow of not only gas, but also liquid, i.e. it can operate under water.

The low-noise operation during flight is ensured by the absence of external propellers. A greater load capacity is enabled by the Magnus effect.

Therefore, the task set for the author has been completed.

1. Aerial vehicle using Magnus effect with a polyhedral body, which has the rotational cylinders with engines installed along its perimeter, with the body having inlets leading to the intake area and the gas supply area located within the body, where the centrifugal impellers with engines are installed at the top and at the bottom; at the outlet of the gas intake and supply area, as well as along the perimeter, there are flow channels located at the top and at the bottom, having the form of cells that extend into the tunnel that narrows at the outlet just before the cylinder, wherein the top and bottom flow channels are independent and not connected to each other.

2. The method of operation of the aerial vehicle using Magnus effect is that ram air gets into the body through the inlets, and the rotation of impellers ensures the intake and supply of gas, and the forced ram air generated by the rotation of centrifugal impellers passes through the cells of flow channel, splitting one continuous flow into several smaller ones and making its supply evenly distributed along the entire length of cylinders; after the cells, the flows pass through the tunnel where they are narrowed and get to the rotating cylinders, wherein the narrowing of gas flows increases the velocity of gas, while reducing its impact on the surface area of cylinders; and the forced ram air produces Magnus effect on each cylinder, wherein the torque of upper impeller is compensated by the torque of lower impeller.
